(19) United States
(12) Patent Application Publication
(10) Pub. No.: US 2019/0335048 A1
(43) Pub. Date: Oct. 31, 2019

(54) SERVER, IMAGE FORMING SYSTEM AND MANAGEMENT METHOD FOR MANAGING IMAGE FORMING APPARATUSES

(71) Applicant: KYOCERA Document Solutions Inc., Osaka (JP)

(72) Inventor: Tan Jaclyn Tiffanie, Osaka (JP)

(73) Assignee: KYOCERA Document Solutions Inc., Osaka (JP)

(21) Appl. No.: 16/393,503

(22) Filed: Apr. 24, 2019

(30) Foreign Application Priority Data
Apr. 27, 2018 (JP) 2018-086384

(51) Int. Cl. H04N 1/00

(52) U.S. Cl. CPC H04N 1/00511; H04N 1/00464; H04N 1/00429

(57) ABSTRACT

Provided is a server that prevents incorrect setting or the like of a delegating group in an image forming system. A hierarchy classifying unit classifies groups in which users related to management of the image forming apparatuses are integrated in a tree structure. A group type setting unit sets the types of the groups classified by the hierarchy classifying unit to normal groups and delegating groups. A browsing managing unit, when the user logs in from the terminal, performs exclusive management that does not allow browsing of a group set as a delegating group by the group type setting unit, even by a user belonging to an upper group.

### INCORPORATION BY REFERENCE

This application is based on and claims the benefit of priority from Japanese Patent Application No. 2018-086384 filed on Apr. 27, 2018, the contents of which are hereby incorporated by reference.

### BACKGROUND

This disclosure relates to a server, an image forming system, and a management method, and in particular to a server, an image forming system, and a management method for managing image forming apparatuses.

There are image forming apparatuses such as a MFP (multifunctional peripheral) capable of printing documents and images. In recent years, most companies have installed multiple image forming apparatuses in their offices.

Conventionally, there is an image forming system that manages these image forming apparatuses. The image forming apparatuses are used by various businesses and people on this image forming system.

In a conventional image forming system, in order to distinguish and manage companies or the like using the same system, companies or the like are classified as a group in the system. On this basis, each user of the image forming system is granted access rights only to the groups to which the user belongs.

In a typical technique there is a license management server. The license management server includes a license management DB, a group management DB, a group recognizing unit, and a license managing unit. The license management DB stores information regarding licenses for performing remote maintenance and the like on one or more image forming apparatuses installed at a customer site. The group management DB stores information on groups representing organizations that will make a contract for acquiring a license, and group types indicating the types of groups. The group recognizing unit extracts a group from the group management DB. The license managing unit determines the group type of the extracted group, and grants a license based on the determined group type.

In this typical technique, groups are hierarchically managed in a tree structure.

Here, there are cases where it is desired to set a group for a company or the like that delegates management of a plurality of image forming apparatuses. For this reason, in the typical technique described above, a group of companies or the like (hereinafter referred to as a “delegating group”) that delegates management to the lower level of a group to which an manager who supervises the country or the like belongs, may be set with attributes that are not different from those of the normal group. In other words, the above-described typical technique does not distinguish between a “delegating group” and a normal lower group.

### SUMMARY

The server according to the present disclosure is a server of an image forming system for managing image forming apparatuses. The server includes a hierarchy classifying unit, a group type setting unit, and a browsing managing unit. The hierarchy classifying unit classifies groups in which users related to management of the image forming apparatuses are integrated in a tree structure. The group type setting unit sets the types of the groups classified by the hierarchy classifying unit to normal groups and delegating groups The browsing managing unit performs exclusive management that does not allow browsing of a group set as a delegating group by the group type setting unit, even by a user belonging to an upper group.

The image forming system according to the present disclosure is an image forming system for managing image forming apparatuses, including image forming apparatuses, terminals, and a server. The server includes a hierarchy classifying unit, a group type setting unit, and a browsing managing unit. The hierarchy classifying unit classifies groups in which users related to management of the image forming apparatuses are integrated in a tree structure. The group type setting unit sets the types of the groups classified by the hierarchy classifying unit to normal groups and delegating groups The browsing managing unit, when the user logs in from the terminal, performs exclusive management that does not allow browsing of the group set as the delegating group by the group type setting unit, even by a user belonging to an upper group.

The management method according to the present disclosure is a management method executed by a server of an image forming system for managing image forming apparatuses. The server classifies groups in which users related to management of the image forming apparatuses are integrated in a tree structure. The server sets the types of the classified groups to normal groups and delegating groups. The server performs exclusive management that does not allow browsing of the group set as the delegating group, even by the user belonging to the upper group.

### BRIEF DESCRIPTION OF THE DRAWINGS

FIG. 1 is a system configuration diagram of an image forming system of an embodiment according to the present disclosure.

FIG. 2 is a block diagram illustrating a control configuration of the server illustrated in FIG. 1.

FIG. 3 is a block diagram illustrating a functional configuration of the image forming system of an embodiment according to the present disclosure.

FIG. 4 is a conceptual diagram of a tree structure in the account settings illustrated in FIG. 3.

FIG. 5 is a flowchart of a group browsing management process of an embodiment according to the present disclosure.

FIG. 6A is a screen example of the browsing management process illustrated in FIG. 5.

FIG. 6B is a conceptual diagram of a apparatus to be browsed in the screen example illustrated in FIG. 6A.

FIG. 7A is a screen example of the browsing management process illustrated in FIG. 5.

FIG. 7B is a conceptual diagram of a apparatus to be browsed in the screen example illustrated in FIG. 7A.

FIG. 8A is a screen example of the browsing management process illustrated in FIG. 5.

FIG. 8B is a conceptual diagram of an apparatus to be browsed in the screen example illustrated in FIG. 8A.

FIG. 9A is a screen example of the browsing management process illustrated in FIG. 5.

FIG. 9B is a screen example of the browsing management process illustrated in FIG. 5.

### DETAILED DESCRIPTION

### Embodiments

[System Configuration of Image Forming System X]

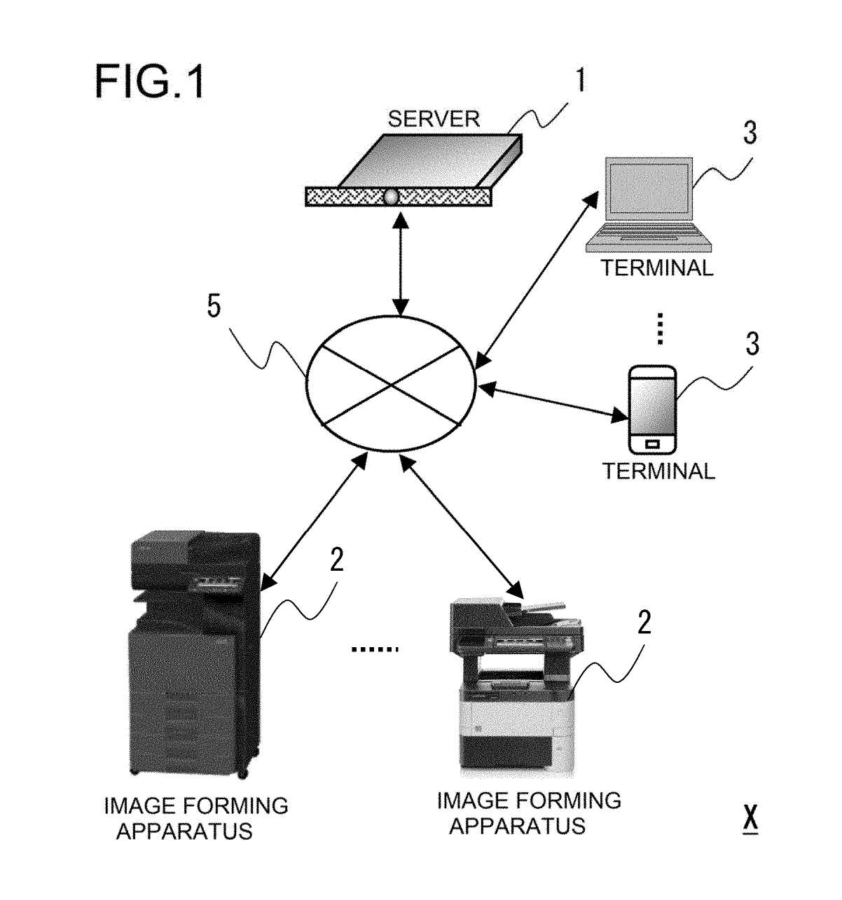

First, the system configuration of the image forming system X of an embodiment according to the present disclosure will be described with reference to FIG. 1.

The image forming system X of the present embodiment includes a server 1, image forming apparatuses 2, and terminals 3.

The server 1 is an information processing apparatus such as a PC (Personal Computer), a general-purpose machine, or the like that maintains and manages the image forming apparatuses 2. The server 1 remotely manages each image forming apparatus 2, and mainly performs billing, maintenance, and service correspondence. The server 1 may also be a server on a so-called “cloud”.

Incidentally, in the present embodiment, the server 1 may execute a service (service, daemon) for transmitting and receiving e-mails or messages by various messengers (hereinafter simply referred to as “e-mails”) for notifying customers.

In addition, the server 1 may execute image processing, OCR (Optical Character Recognition) processing, classification processing, transmission processing to an e-mail or shared folder (document box, storage folder), business or office DMS (Document Management System) and the like.

The image forming apparatuses 2 are information processing apparatuses such as an MFP, a network scanner, a document scanner, a network FAX, a printer, or the like. In addition, the image forming apparatuses 2 may also perform copying, printing, scanning, facsimile transmission, and the like of a document.

The terminals 3 are terminals used by users related to management of the image forming apparatuses 2. Such a user may be a customer, a service person, a support staff member, an administrator or the like.

More specifically, a terminal 3 is a PC, a mobile phone, a smartphone, a tablet, a PDA (Personal Data Assistant), a business support terminal, a dedicated terminal, or the like. In addition, the terminals 3 operate using various general-purpose OS (Operating Systems) and the like. Moreover, on the terminals 3, various application software (Application Software, applications, hereinafter simply referred to as “apps”) may be installed.

The network 5 is a LAN (Local Area Network), or a WAN (Wide Area Network) such as the Internet, a mobile phone network or the like. Moreover, the network 5 may be a voice telephone line, a dedicated line, or the like. In addition, the network 5 may be configured to be connected to a WAN via another network. Further, the network 5 may form a VPN (Virtual Private Network).

### (Control Configuration of Server 1)

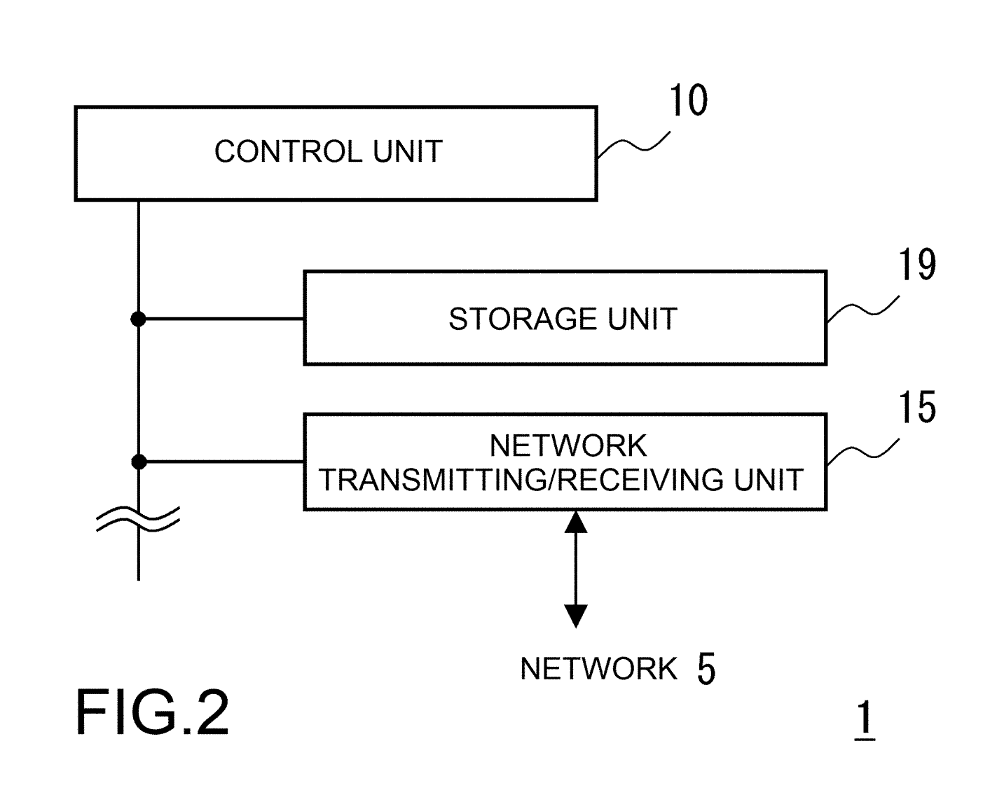

Next, the control configuration of the server 1 will be described with reference to FIG. 2.

The server 1 includes a control unit 10, a network transmitting/receiving unit 15, a storage unit 19, and the like. Each unit is connected to the control unit 10, and the operation thereof is controlled by the control unit 10.

The control unit 10 is an information processing unit such as a GPU (General Purpose Processor), a CPU (Central Processing Unit), a MPU (Micro Processing Unit), a DSP (Digital Signal Processor), a GPU (Graphics Processing Unit), ASIC (Application Specific Integrated Circuit, application specific processor) or the like.

The control unit 10 reads a control program stored in the ROM or the HDD of the storage unit 19, develops the control program in the RAM, and executes the control program to operate as each unit of functional blocks described later.

The network transmitting/receiving unit 15 is a network connecting unit including a LAN board, a wireless transceiver, or the like for connecting to an external network such as a LAN, a wireless LAN, a WAN, a mobile phone network, and the like.

The network transmitting/receiving unit 15 transmits and receives data on a data communication line, and transmits and receives voice signals on a voice telephone line.

The storage unit 19 is a non-transitory recording medium such as a semiconductor memory such as ROM (Read Only Memory), RAM (Random Access Memory) or the like, a HDD (Hard Disk Drive), or the like.

A control program for performing operation control of the server 1 is stored in the ROM or the HDD of the storage unit 19. In addition to this, the storage unit 19 also stores the account settings 200 of the users. Moreover, the storage unit 19 may include a storage folder area for each user.

Incidentally, in the server 1, the control unit 10 may be integrally formed, such as a CPU with built-in GPU, a chip-on-module package, an SOC (System On a Chip), or the like.

Moreover, the control unit 10 may be internally equipped with a RAM, a ROM, a flash memory, or the like.

### [Functional Configuration of Server 1]

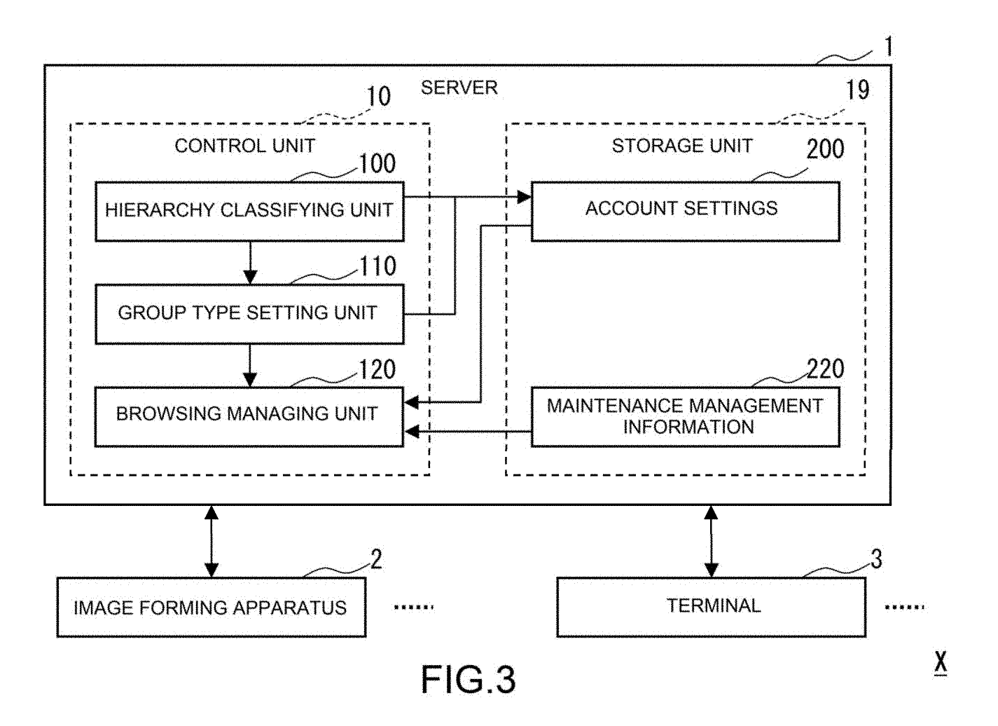

Here, the functional configuration of the server 1 of the image forming system X of an embodiment according to the present disclosure will be described with reference to FIG. 3.

The control unit 10 of the server 1 includes a hierarchy classifying unit 100, a group type setting unit 110, and a browsing managing unit 120

The storage unit 19 stores account settings 200, and maintenance management information 220.

The hierarchy classifying unit 100 classifies groups in which users related to the management of the image forming apparatuses 2 are integrated in a tree structure.

The group type setting unit 110 sets the type of the group classified by the hierarchy classifying unit 100 to a normal group and a delegating group.

When a user logs in from a terminal 3 or the like, the browsing managing unit 120 performs browsing management of “exclusive management” for groups set in the delegating groups by the group type setting unit 110 that are not allowed browsing even by users belonging to an upper group. The browsing managing unit 120 dynamically creates and transmits pages using, for example, CGI (Common Gateway Interface) or ASP of a WWW server.

Moreover, in addition to exclusive management, the browsing managing unit 120 may allow selection of browsing management of “selected groups only” in which information directly related to selected groups is browsed, and browsing management of “accessible groups” in which all accessible groups are browsed.

The account settings 200 is a database that stores a user ID (Identification), a password, a license, authority and permission information, and the like of a user of a terminal 3. In addition, the account settings 200 include information regarding the image forming apparatuses 2 to be maintained and managed, information regarding the correspondence between the users and the image forming apparatuses 2, and the like. Moreover, the account settings 200 store information regarding the groups to which the respective users belong, including the tree structure.

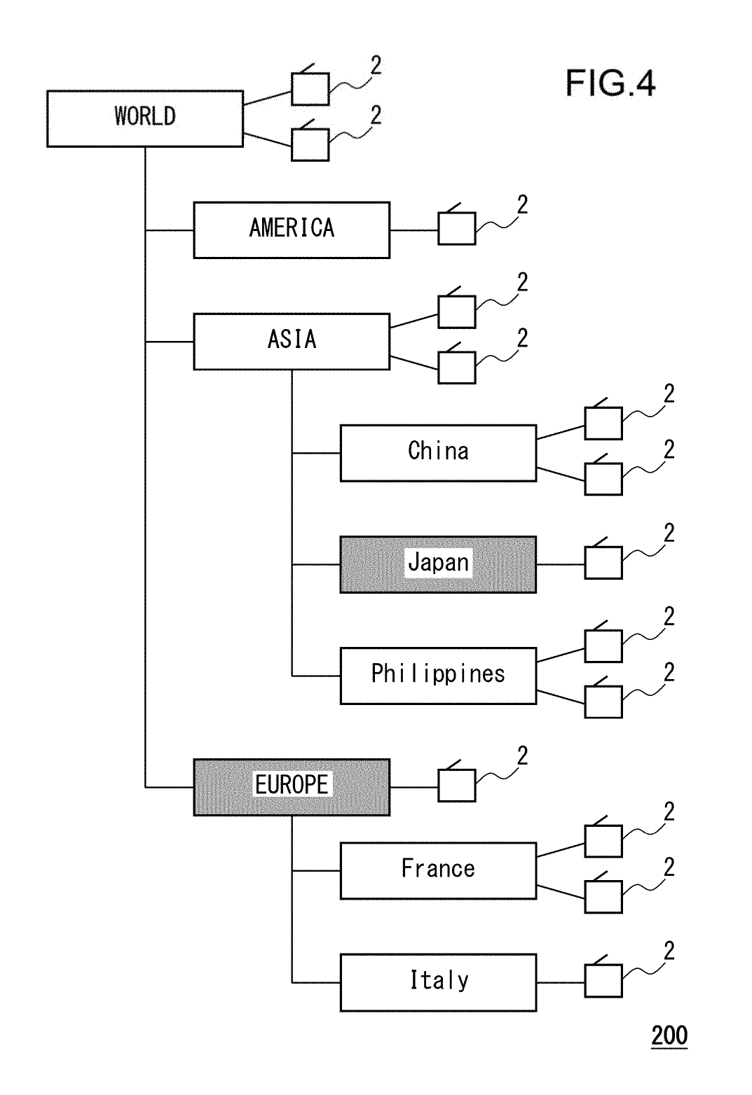

FIG. 4 illustrates an example of the tree structure of groups of the account settings 200.

In this example, each group manages the image forming apparatuses 2 under the group's control. In addition, each group is set to have a hierarchical structure. Moreover, each group is set to be a normal group or a delegating group.

In this example, the group “WORLD” is set as the highest group and the respective groups “AMERICA”, “ASIA”, and “EUROPE” are set under that group. In addition, “China”, “Japan”, and “Philippines” are set under the “ASIA” group. Similarly, the groups “France” and “Italy” are set under the group “EUROPE”. Moreover, in this example, the group “Japan” and group “EUROPE” indicated by gray the inside the square are set as delegating groups.

The maintenance management information 220 is information for maintenance management of the image forming apparatuses 2. This maintenance management information may include information such as logs, diagnostic data, counts such as the number of output sheets or the like, billing, installation location (customer environment) of the image forming apparatuses 2, customer contact information, and the like. In addition, the maintenance management information 220 may include information on specific contents regarding failure or maintenance from the customer.

Here, the control unit 10 of the server 1, by executing the control program stored in the storage unit 19, functions as the hierarchy classifying unit 100, the group type setting unit 110, and the browsing managing unit 120.

In addition, each unit of the server 1 described above is a hardware resource for executing the image forming method according to the present disclosure.

Incidentally, a part or an arbitrary combination of the above-described functional configurations may be hardware-configured with an IC, programmable logic, FPGA (Field-Programmable Gate Array), or the like.

### [Group Browsing Management Process by Server 1]

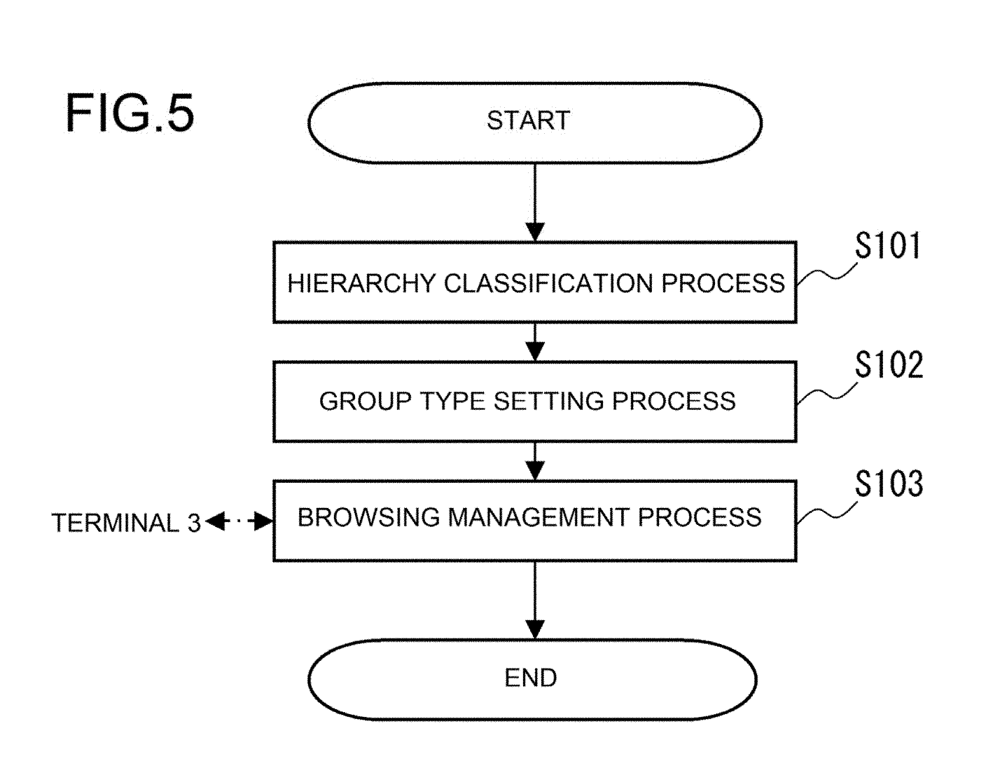

Next, the group browsing management process by the server 1 of the image forming system X of an embodiment according to the present disclosure will be described with reference to FIGS. 5 to 9B.

In the group browsing management process according to the present embodiment, groups in which users related to the management of the image forming apparatuses are integrated are classified in a tree structure. Then, the type of the classified groups is set to be a normal group or a delegating group. For groups that are set to be a delegating group, exclusive management is performed so that even users belonging to a superior group are not allowed browsing. In addition, other browsing management may also be selected.

In the group browsing management process according to the present embodiment, mainly the control unit 10 of the server 1 cooperates with each unit and executes the program stored in the storage unit 19 using hardware resources.

The details of the group browsing management process of the present embodiment will be described step by step below with reference to the flowchart in FIG. 5.

### (Step S101)

First, the hierarchy classifying unit 100 performs a hierarchy classification process.

The hierarchy classifying unit 100 classifies groups in which users related to the management of the image forming apparatuses 2 are integrated in a tree structure.

The image forming system X of the present embodiment includes many groups representing different companies using the system.

In the case where access is made from a management terminal such as an administrator or the like of the image forming system X, the hierarchy classifying unit 100 classifies users related to management of the image forming apparatuses 2 into hierarchies and sets that in the account settings.

### (Step S102)

Next, the group type setting unit 110 performs a group type setting process.

The group type setting unit 110 sets the type of the group classified by the hierarchy classifying unit 100 as a normal group or a delegating group.

A user registered by the image forming system X of the present embodiment usually manages a plurality of groups.

Therefore, as described above, the group type setting unit 110 may set a group to two kinds of groups, a “normal group” and a “delegating group”.

Here, a delegating group of the present embodiment is a group to which an administrator or a manager is assigned or delegated for managing each of the groups. In the present embodiment, a delegating group is a group of an upper hierarchy.

On the other hand, a normal group is a group that follows the management of the delegating group above it. Administrators or managers are not specifically assigned to manage normal groups. Instead, a normal group depends on the management of the delegating group above it.

### (Step S103)

Next, the browsing managing unit 120 performs a browsing management process.

When a user logs in via a terminal 3, the browsing managing unit 120 reads the account settings 200 and the maintenance management information 220, and transmits the web page corresponding to the group that the logged-in user belongs to.

Here, the user may change the method of the browsing range in the tree structure of the group by the “Include” option in the group window.

The following three methods may be set for this browsing range:
Selected group only (Exclusive to this group)
Exclusive management (Exclusively managed)
Accessible groups (All accessible)

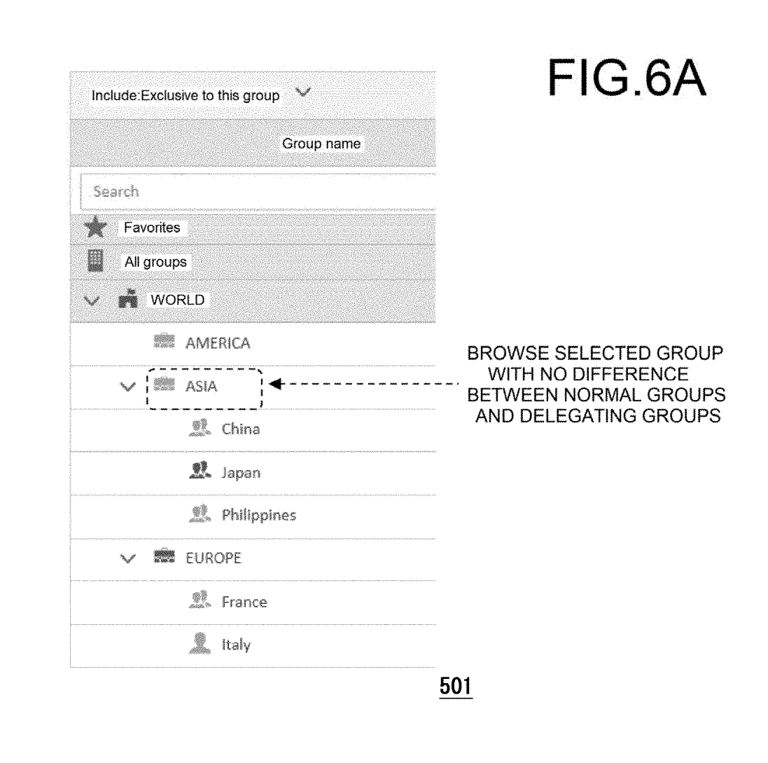

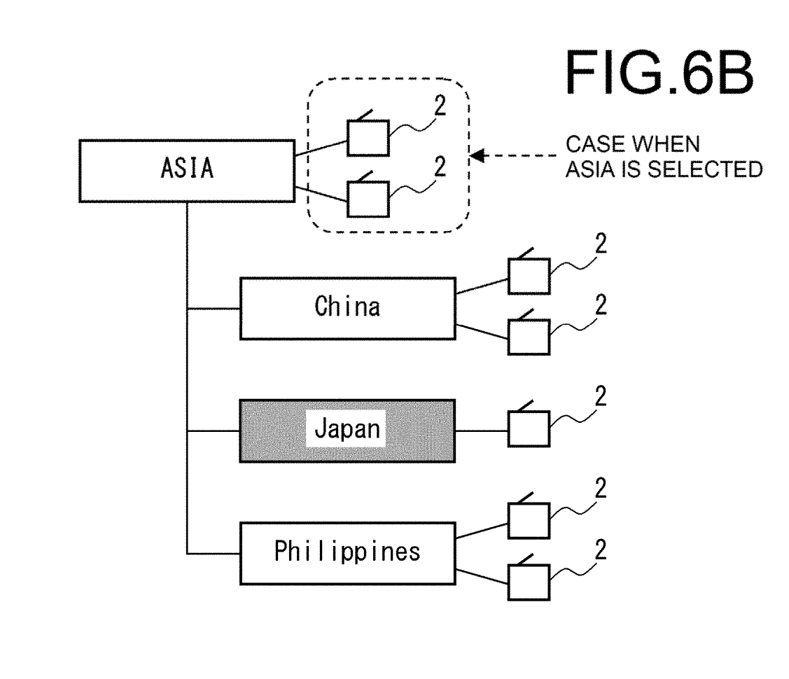

The browsing range of “selected group only” will be described with reference to FIG. 6A and FIG. 6B.

In this browsing range, the browsing managing unit 120 allows browsing of information directly related to the selected group. In other words, the selected group may be browsed without any difference for a normal group or delegating group.

As illustrated in the screen example 501 in FIG. 6A, when the group “ASIA” is selected, only the information of the group “ASIA” is displayed. More specifically, as illustrated in FIG. 6B, the image forming apparatuses 2 under the “ASIA” group may be browsed.

Similarly, when the group “WORLD” is selected, only the information of the group “WORLD” is displayed. In this case as well, the image forming apparatuses 2 under group “WORLD” may be browsed. Similarly, in the case of the groups “AMERICA”, “EUROPE”, “China”, “Japan”, “Philippines”, “France”, and “Italy”, only the information of those groups may be browsed.

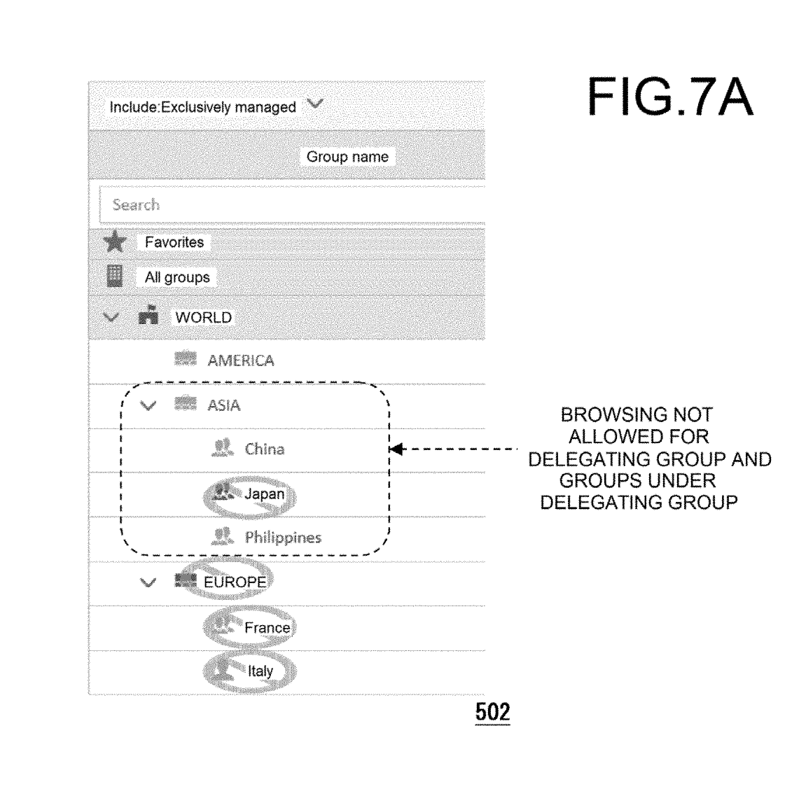

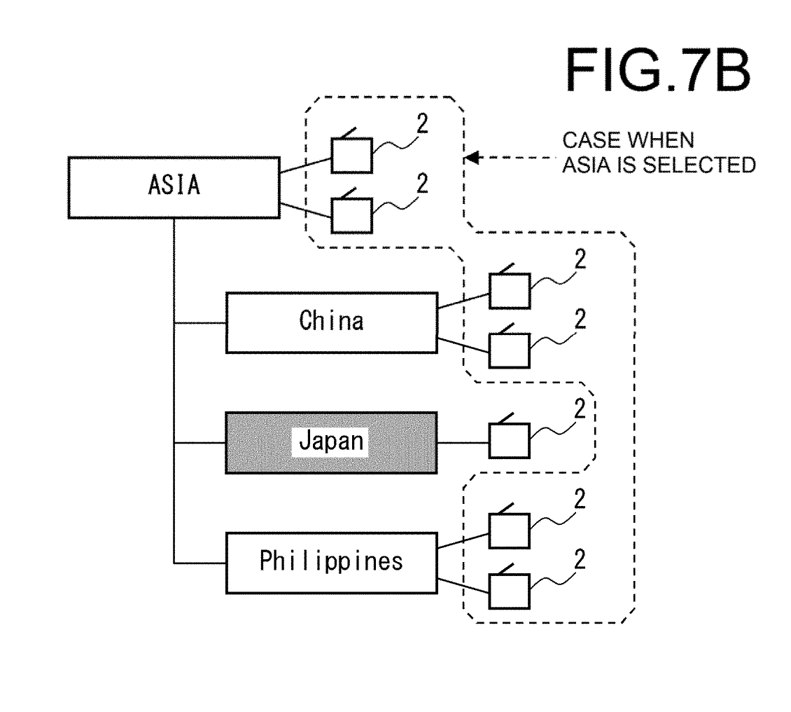

The browsing range of “exclusive management” will be described with reference to FIGS. 7A and 7B.

In this browsing range, the browsing managing unit 120 illustrates information regarding the selected group and the lower normal groups. At this time, a delegating group and groups under the delegating group allow exclusive browsing without allowing browsing of information.

In the screen example 502 of FIG. 7A, when the group “ASIA” is selected, information of groups “ASIA”, “China”, and “Philippines” is displayed. This is because “Japan” is set as a delegating group as described above. More specifically, as illustrated in FIG. 7B, the image forming apparatuses 2 under the groups “ASIA”, “China”, and “Philippines” may be browsed.

Likewise, when the group “WORLD” is selected, information on the groups “WORLD”, “AMERICA”, “ASIA”, “China”, and “Philippines” is displayed. In this example, as described above, “Japan” and “EUROPE” are delegating groups. Therefore, group “Japan”, group “EUROPE”, and the lower groups “France” and “Italy” may not be browsed.

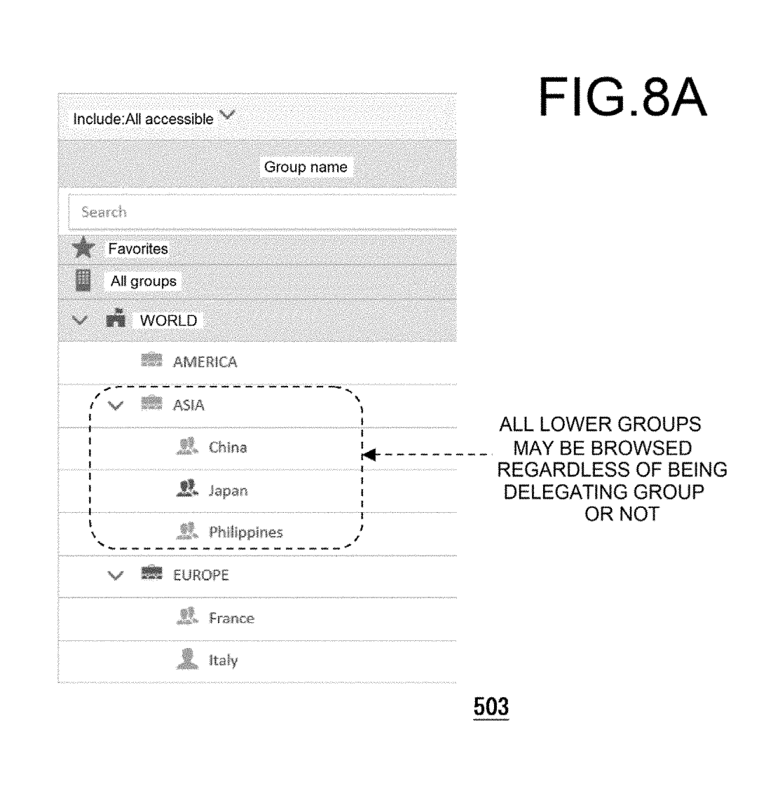

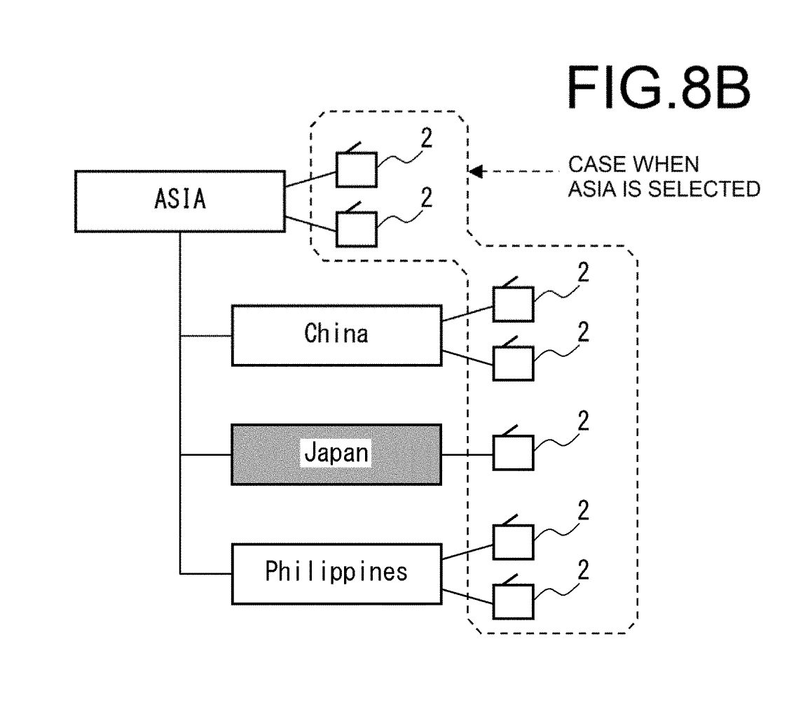

The browsing range of “accessible groups” will be described with reference to FIG. 8A and FIG. 8B.

In this browsing range, the browsing managing unit 120 indicates the information of the selected group and the groups under that group regardless of being a normal group or delegating group.

In the screen example 503 of FIG. 8A, when group “ASIA” is selected, information of groups “ASIA”, “China”, “Japan” and “Philippines” is displayed. In other words, as illustrated in FIG. 8B, the image forming apparatuses 2 under the groups “ASIA”, “China”, “Japan”, and “Philippines” may be browsed.

Similarly, when the group “WORLD” is selected, the information of group “WORLD ” and each lower group is displayed, and the image forming apparatuses 2 under it may be browsed.

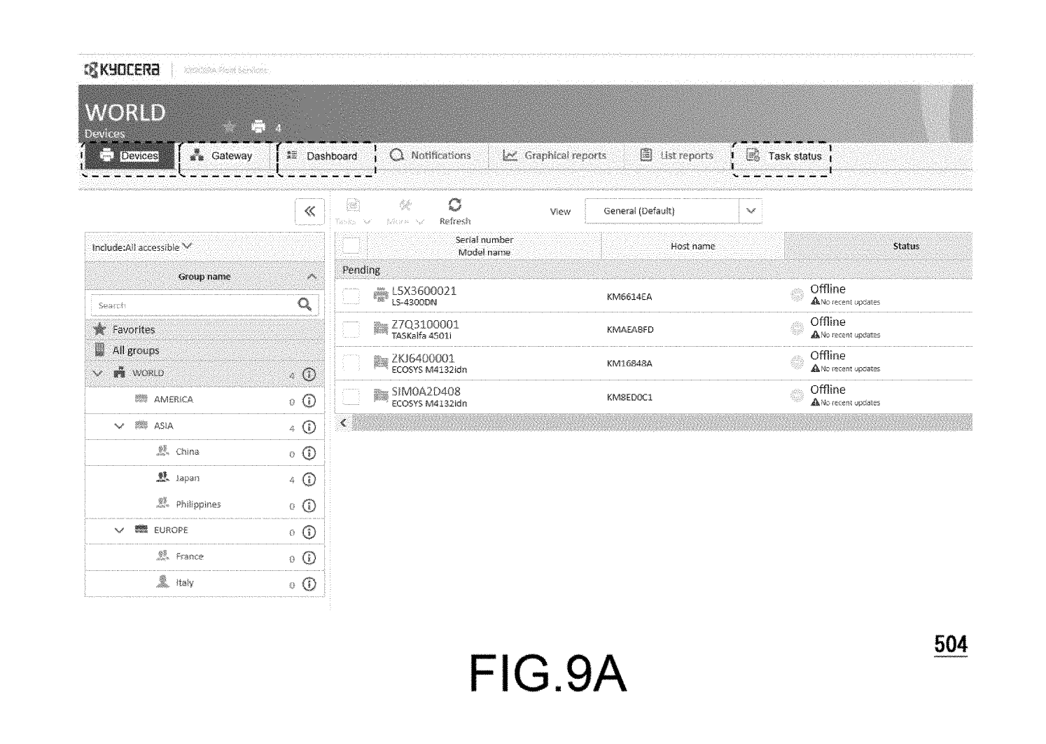

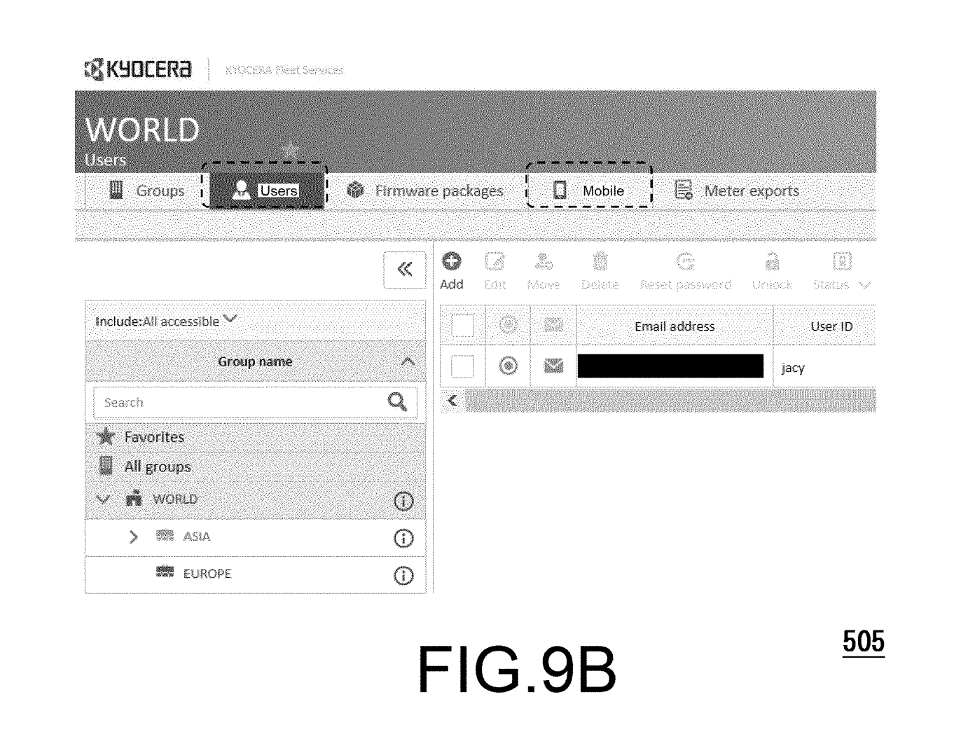

A screen example 504 in FIG. 9A and a screen example 505 in FIG. 9B illustrate specific examples of information managed by the tree structure of the groups.

In the present embodiment, the browsing managing unit 120 changes the browsing range for the following information.
Image forming apparatus 2 being managed
Gateway
Dashboard
Task status
Managed users
Managed terminals 3

In these screen examples 504 and 505, by pressing down a part surrounded by a dotted line, the user can issue a display instruction.

As described above, it is possible to easily change the browsing range of the tree structure of the group based on the information that a user wants to manage while browsing the web page of the information the user wants to see.

This completes the group browsing management process of an embodiment according to the present disclosure.

With configuration as described above, the following effects may be obtained.

In the typical technique described above, there are cases in which settings and the like were performed incorrectly without noticing that the apparatus is an image forming apparatus of a delegating group.

On the other hand, the image forming system X of an embodiment according to the present disclosure is an image forming system that manages image forming apparatuses including a server 1, image forming apparatuses 2, and terminals 3. The server 1 includes: a hierarchy classifying unit 100 for classifying groups in which users related to management of image forming apparatuses 2 are integrated in a tree structure; a group type setting unit 110 for setting the types of the groups classified by the hierarchy classifying unit 100 into normal groups and delegating groups; and a browsing managing unit 120 that, when a user logs in from a terminal 3, performs exclusive management that does not allow browsing of a group set as a delegating group by the group type setting unit 110, even by a user belonging to an upper group.

With this kind of configuration, by the browsing management of “exclusive management”, it is possible to prevent a delegating group from being browsed. Therefore, for lower delegating groups, this helps to prevent situations in which an administrator performs settings or the like by mistake.

In addition, upper groups such as sales companies, dealers or the like using an image forming system must perform management of many lower groups. In this case, it is difficult to browse and check the groups one by one to manage. In such a case, since it is not necessary to check delegating groups, it is possible to reduce the burden on users such as sale companies, dealers and the like.

Moreover, the server 1 of an embodiment according to the present disclosure, in addition to exclusive management, may allow the browsing managing unit 120 to select selected group only browsing management that allows browsing of information directly related to a selected group, and accessible group browsing management that allows the browsing of all accessible groups.

With this kind of configuration, it is possible to deal with a case where an administrator or the like desires to change settings or the like even in the case of a delegating group. Therefore, convenience of use by an administrator or the like may be improved.

In addition, with regard to sales companies and dealers, by making it possible to change the browsing range of groups, it is possible to make operation and monitoring easier.

### [Other Embodiments]

Incidentally, in the above-described embodiment, an example is described in which a web page on which browsing management has been performed using CGI or ASP is transmitted to a terminal 3.

However, it is possible to generate a web page using a generator for generating various dynamic pages such as Java (registered trademark) Script, SSI (Server Side Includes), servlet, PHP or the like, and provide that web page to a user.

Moreover, in the above-described embodiment, although an example of providing a web page by the server 1 on the cloud is described, the web page may also be provided by an image forming apparatus incorporating a web server or a server on an intranet.

Conventionally, setting of the image forming apparatuses of a delegating group is often performed by a company or the like of the delegating group. However, in the typical technique described above, a user belonging to an upper group can unconditionally browse and change or the like the settings or the like of a lower group.

Therefore, in some cases an administrator or the like does not notice that an image forming apparatus is an image forming apparatus of a delegating group, and sometimes performs settings or the like incorrectly.

The technique according to the present disclosure has been made in view of such a situation, it is an object to provide a server that solves the above-mentioned problems.

According to the present disclosure, the type of a group is set to be a normal group or a delegating group, and for groups set as a delegating group, exclusive management that does not allow browsing, even by a user belonging to an upper group, is performed. As a result, it is possible to provide an image forming system that prevents errors such as an administrator or the like incorrectly performing settings or the like of image forming apparatuses of a delegating group.

In addition, the technique according to the present disclosure may also be applied to an information processing apparatus other than an image forming apparatus. In other words, configuration using a server or the like that is separately connected to a network scanner or a scanner via a USB or the like may be used.

Moreover, needless to say, the configuration and operation of the above-described embodiments are examples and can be appropriately changed and executed within a range that does not depart from the gist of the present disclosure.

What is claimed is:

1. A server that is a server of an image forming system for managing image forming apparatuses, comprising:
a hierarchy classifying unit for classifying groups in which users related to management of the image forming apparatuses are integrated in a tree structure;
a group type setting unit for setting the types of the groups classified by the hierarchy classifying unit to normal groups and delegating groups; and
a browsing managing unit that performs exclusive management that does not allow browsing of a group set as a delegating group by the group type setting unit, even by a user belonging to an upper group.

2. The server according to claim 1, wherein
the browsing managing unit
in addition to exclusive management, may select selected group only browsing management that allows browsing of information directly related to a selected group, and accessible group browsing management that allows browsing of all accessible groups.

3. An image forming system that is an image forming system for managing image forming apparatuses, including image forming apparatuses, terminals, and a server, wherein
the server comprises:
a hierarchy classifying unit for classifying groups in which users related to management of the image forming apparatuses are integrated in a tree structure;
a group type setting unit for setting the types of the groups classified by the hierarchy classifying unit to normal groups and delegating groups; and
a browsing managing unit that, when the user logs in from the terminal, performs exclusive management that does not allow browsing of the group set as the delegating group by the group type setting unit, even by the user belonging to an upper group.

4. A management method that is a management method executed by a server of an image forming system for managing image forming apparatuses, wherein the server
classifies groups in which users related to management of the image forming apparatuses are integrated in a tree structure;
sets the types of the classified groups to normal groups and delegating groups; and
performs exclusive management that does not allow browsing of the group set as the delegating group, even by the user belonging to the upper group.
